(19) United States
(12) Patent Application Publication
(10) Pub. No.: US 2016/0104389 A1
(43) Pub. Date: Apr. 14, 2016

(54) Child's Manipulative for Home and Classroom Behavior Support

(71) Applicant: Jane Humphries, Oklahoma City, OK (US)

(72) Inventor: Jane Humphries, Oklahoma City, OK (US)

(21) Appl. No.: 14/512,501

(22) Filed: Oct. 13, 2014

(51) Int. Cl. G09B 19/00

(52) U.S. Cl. CPC G09B 19/00

(57) ABSTRACT

A device suitable to provide sensory stimulation to children is described. The device may be portable or fixed to a child's school desk or may similarly be used in the home, public areas or otherwise, primarily of cloth construction which provides a variety of tactile and sensory stimuli suitable to help the child to maintain appropriate social or classroom behavior under a variety of local circumstances, such as when the holder is stressed or during transition periods in classrooms. The device is suitable for use from infancy to adulthood to meet the needs of users for whom tactile stimulation can provide attention redirection.

### FIELD

This invention relates generally to hand-held, lap-held or otherwise portable or fixable devices suitable to provide a child with tactile and sensory stimulation sufficient to help support the child's need to focus the child's behavior in classrooms and similar settings. The invention supports a range of tactile and sensory sensations sufficient to attract a child's attention but not so stimulative as to distract the child from classroom activities nor to cause the child to engage in disruptive behavior.

### BACKGROUND OF THE INVENTION

Compared to the classroom of fifty years ago, the classroom of today has changed remarkably. Apart from the obvious changes in the types and extent of technologies used in the classroom, the composition of students has changed as well. One significant change has occurred as to efforts to “mainstream” special needs children—that is, under the Individuals with Disabilities Education Act, children with physical, mental, behavioral or emotional issues stay in the classroom to the fullest extent possible, with a strong emphasis placed on inclusion using modification rather than exclusion to separate facilities.

While this has greatly benefited hundreds of thousands of children in the US since the 1970s, it does create burdens on classroom teachers. Students with emotional or behavioral issues, who might previously have been sent to self-contained special education classrooms simply to help maintain order in the mainstream classroom, are now routinely kept in the mainstream classroom and may often be provided with additional classroom support, in the form of paraprofessionals, behavior specialists and others. These support personnel may use a variety of behavior modification and re-direction techniques which can be used to help students maintain appropriate behavior in the classroom. Various forms of token systems, rewards, and behavior modification methods are used on a daily basis in most schools, However, just as classrooms today may include a range of student types, so, too, do they require access to a similarly broad range of support device types.

Obtaining support devices for the classroom, however, can be problematic. School budgets have been strained and cut across the country. Teachers currently spend a record amount of money out-of-pocket, on average approximately $350 per year per teacher, to obtain necessary school supplies for their classroom. A critical issue exists that support devices for some students cannot be and are not obtained simply because they are too costly. As a result, classroom teachers struggle to teach all because of the additional obligations to a few.

There is a need for a device which can help support appropriate classroom behavior by children with emotional or behavioral issues. There is a further need for such a device which can be provided to such children in a way which does not otherwise distract from effective classroom functioning, but which can be used by a child at a desk, during transition times, or at times of stress for the child. There is a further need for such a device which can be obtained by teachers, support staff or others inexpensively. The present invention meets these needs.

### SUMMARY OF THE INVENTION

It should be regarded that while the present invention is described in general relative to a handheld, portable device suitable for helping a child maintain focus and appropriate behavior in a classroom setting, the invention is not limited thereto. The present invention may be practiced in any application in which a tactile or sensory-based device may be used to help support behavioral control by the user, whether portable, fixed, wearable or otherwise. Hereinafter, the invention is referred to as the “device,”

In a preferred embodiment, the device is comprised of quilted cloths sewn together or otherwise suitably manufactured such that the types of cloths used in the combination provide tactilely and sensorily different feels to the holder. Referring to FIG. 1, the device 10 is comprised of visually and tactilely distinct fabrics conjoined in a manner suitable for allowing a plurality of types of visual and tactile variations to be presented in a single object. While typically sewing is sufficient for joining parts of the device, any suitable manner of joining may be made. For example, in the preferred embodiment, five fabric panels are presented, Panel 11 comprises a brightly colored cloth on which or into which are manufactured bumps, knobs or other tactilely distinct “feels.” Panel 12 is comprised of a similarly bright cloth colored m a distinctly different color than panel 11. Panel 12 also has manufactured into it or onto it tactilely distinct “feels,” For this invention, “feels” refers to areas in a piece of cloth in which some unusual artifact can be felt using touch, either with fingers or elsewhere with exposed skin.

Panel 13 comprises a piece of cloth in which no distinct feel exists. Panel 13 may, to the contrary, display an image, color or figure of interest to a child, while providing a soft or smooth tactile feel to the child. Similarly different looks and feels are provided for panels 14 and 15.

In the preferred embodiment the device 10 is quilted, with varying thicknesses of quilting provided either between individual product units or between different panels in a single unit. A ribbing 18, either on the border of the preferred embodiment or between panels 19, may be provided.

In use the device is provided to a child requiring emotional or behavioral support in the classroom, the home or elsewhere. The device is sized to be easily held by a child using one or two hands. In the preferred embodiment, the device is approximately 12 inches by 12 inches, although many variations in size are allowed. The child is allowed and encouraged to hold, squeeze, stroke, or otherwise manipulate the device so as to explore the tactile variations between the panels. Additionally, the child may engage the device visually by seeking out interesting or desirable characters, colors, numbers, letters or other images displayed in any of the panels.

The device is designed to be cost-effective. While the device balances the need to engage a child meaningfully so at to improve classroom behavior or behavior at home or in social settings, it likewise is designed to be affordable to teachers seeking behavioral and emotional support devices.

### BRIEF DESCRIPTION OF THE DRAWINGS

FIG. 1 depicts a perspective view of an idealized embodiment of the device.

FIG. 2 depicts an alternative embodiment of the device in which a ribbing is disposed between quilted panels.

FIG. 3 depicts a cross-section of an embodiment of the device.

FIG. 4 depicts a perspective view of an alternative embodiment of the device in which tactile objects have been sewn into the device.

FIG. 5 depicts a perspective view of an additional alternative embodiment of the device which may be disposed under a desk and provide rough, multiple texture or otherwise distinctive sensory feels.

### DETAILED DESCRIPTION OF THE EMBODIMENTS

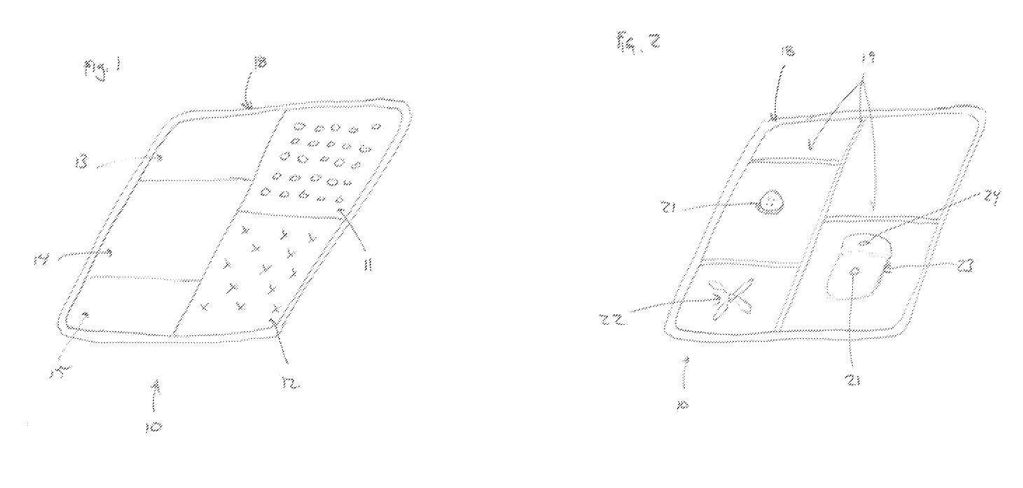

Referring to FIG. 1, a preferred embodiment of the device 10 is comprised of visually and tactilely distinct fabrics sewn together in a manner suitable for allowing a plurality of types of visual and tactile variations to be presented in a single object. For example, in the preferred embodiment, five fabric panels are presented. Panel 11 comprises a brightly colored cloth on which or into which are manufactured bumps, knobs or other tactilely distinct “feels.” Panel 12 is comprised of a similarly bright cloth colored in a distinctly different color than panel 11, Panel 12 also has manufactured into it or onto it tactilely distinct “feels.” For this invention, “feels” refers to areas in a piece of cloth in which some unusual artifact can be felt using touch, either with fingers or elsewhere with exposed skin. The identification of these feels is purely exemplary. These and other tactile feels may be used in any combination. Panel 13 comprises a piece of cloth in which no distinct feel exists. Panel 13 may, to the contrary, display an image, color or figure of interest to a child, while providing a soft or smooth tactile feel to the child. Similarly different looks and feels are provided for panels 14 and 15, The preferred embodiment of the device 10 is quilted, with varying thicknesses of quilting provided either between individual product units or between different panels in a single unit. Referring to FIG. 3, a cross-sectional view of the embodiment reflects different thicknesses of quilting disposes between panels. In this FIG. 3, a panel 30 is comprised of top piece of tactile fabric 35 and a bottom piece of fabric 36, between which is disposed a quilting pad 32 of thickness X. Similarly, a panel 31 is comprised of a top piece of tactile fabric 37 and a bottom piece of fabric 38, between which is disposed a quilting pad 33 of thickness Y. in the preferred embodiment, allowed relationships between X and Y include X=Y, X>Y, X<Y. Materials allowed for the quilting materials further allow one to have greater or less stiffness than the other or further to have an internal or integral tactile structure which may be of interest to a child. The thickness or thinness of the quilting pads X and Y is determined by manufacturing limits and the ability of a child to manipulate the device. In typical use, quilting pads of ½ inch and ¼ inch.

In use, at times of stress for a child or at any time in which classroom routine may be disrupted by internal or external causes, a child with behavioral or emotional issues may be apt to lose focus and engage in disruptive behavior. The disruptive behavior may take a wide range of forms, including tantrums, acting out, talking aloud, walking or running around the classroom and others. For a child with known behavior or emotional issues, the teacher or a support staff member may keep the device 10 near or in the child's desk, so as to be able to place the device in the child's hands as quickly as possible before or after the first sign of disruptive behavior. The child may then feel, hold, manipulate, rub or stroke the device 10, as desired, allowing the child to focus on the device 10 in some way rather than on less appropriate behavior, Similarly, the child may simply look at the device 10, taking advantage of a color, object or image of interest, so as to direct the child's attention in that direction.

During transition periods, the child may simply carry the device 10 with him or her, such as when the class changes rooms, as for lunch, recess or otherwise. The device 10 serves as a simple, local distraction allowing the child to channel disruptive behavior toward the device 10 while complying with directions provided by the teacher or other personnel.

Similarly, in home or social settings, the device 10 may be used by a parent or caregiver to help support the child during times of stress, changes in routine, when the child feels insecure or at times otherwise known to the parent or caregiver when the child may be prone to engage in disruptive or otherwise inappropriate behavior.

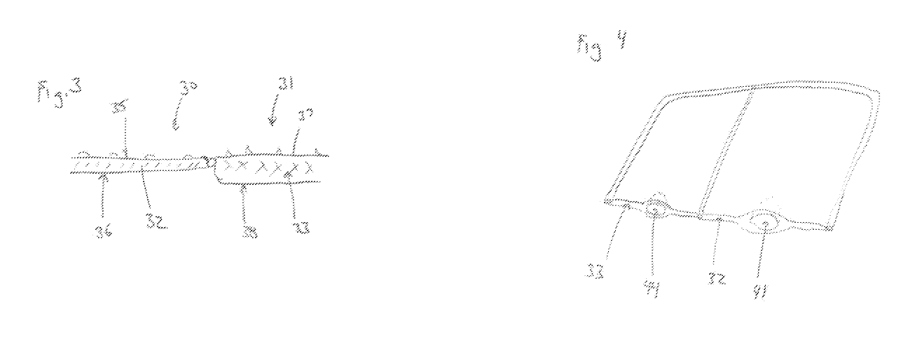

In an alternative embodiment, additional tactile or sensory feels may be disposed on the device 10. Referring to FIG. 2, a ribbing 18, either on the border of the preferred embodiment or between panels 19, may be provided. The ribbing may be designed to provide a noticeably different tactile or sensory feel than any of the panels 11. through 15. in addition, tactilely interesting objects, such as a ribbon 22, a button 21 and button hole 24, a pocket 23 or other manipulative is provided. Ribbing is sewn onto the device by any known means. Generally, a strip of cloth covering a cord is sown in place.

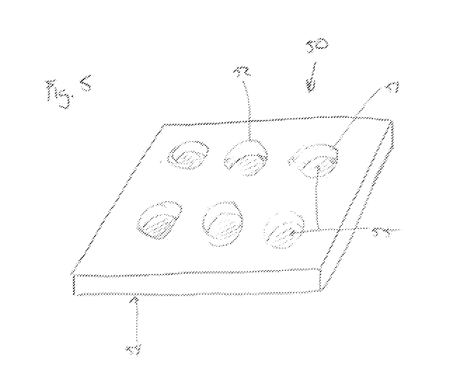

Referring to FIG. 4, in an alternate embodiment, objects may be embedded into the quilting material 32 or 33 or proximal to the quilting material 32 or 33 within the top and bottom layers of fabric 35 through 38. In the alternate embodiment of FIG. 4, a bellows 41 is disposed with a quilting pad 32. In this example, the bellows 41 may be compressed with resistance by the child holding the device 10. This resistive compression may be attractive to the child in itself or may be associated with another feel or noise. Similarly, in FIG. 4, a heat or cold pack 44 is disposed within a quilting pad 33. Support staff, on an as-needed basis, may warm, such as in a microwave oven, or cool, such as in a refrigerator or freezer, the device 10 to allow the provision of a different, distinct tactile sensation for the child. Further additional integral inclusions to the invention may include object which provide a distinct odor, sound, vibration or other sensation. The invention allows inclusions to be exchangeable in order to maintain the interest of a child longer, such as by using zippered or similar closures to allow access to a storage area.

In an alternative embodiment, referring to FIG. 1, panels 11 through 15 of the device may be targeted to suit the age of the user, which may range from infancy to early teens. Colors, tactile feels, patterns and other aspects of each of panels 11 through 15 are age appropriate, which may be viewed as the developmental or emotional age of the child. Similarly, referring to FIG. 4, objects 41 and 44 embedded proximal to or disposed within the quilting 33 or 36 are directed to the age of the user.

In an alternate embodiment, referring to FIG. 1, panels 11 through 15 of the device 10 and, referring to FIG. 4, objects 41 and 44 embedded proximal to or disposed within the quilting 33 or 36 may target a child growing to adulthood. in this embodiment, the sensory feels of the panels 11 through 15, objects 41 and 44 and quilting 32 and 33 may be transitioned to the child's changing maturity. When the child is young, distinctive sensory feels for that age may be used. As the child ages, one or more of each of the panels 11 through 15, objects 41 and 44 and/or quilting 32 or 33 may be changed, modified, altered or upgraded/downgraded to account for the maturing sensory needs of user. This may continue into adulthood. It is known in the field that children who seek out tactile stimulation grow into adults who have this same need. Thus, the device may be used to provide support for the user for a lifetime. However, the specific design can be modified as necessary to meet the continuum of needs of the user.

In an alternate embodiment, the device 10 may be used to support mental activity needs of older users, such as those with Alzheimer's disease or dementia. In this alternate embodiment, it is noted that indications for use may vary significantly from indications for use with infants, toddlers and children. Whereas for infants, toddlers and children the primary indication for use may be to support appropriate classroom or social behavior, the people with Alzheimer's disease or dementia, indications for use include primarily to stimulate and support cognitive activity of the patient. Referring to FIGS. 1 and 4, colors and feels for panels 11 through 15 as well as any embedded object 41 or 44 are incorporated to capture and fix the attention of the patient. For example, it may be useful to incorporate a design, color or other depiction nostalgic or significant to the patient or to print on one of the panels 11 through 15 a photograph of a person, animal or other image of importance to the patient. These themes may range from items of general interest for the age group of the patient to items personal to the patient, It is known in the field that targeted cognitive stimulation has some ability to delay or slow the onset of progress of Alzheimer's disease and other forms of dementia. The device 10 is designed to engage the user to the extent of the user's abilities so as to effect such a delay.

In a further alternate embodiment of the invention, the invention may take a more solid form. Referring to FIG. 5, a plastic rectangular solid 50 is provided in which a plurality of cylindrical holes, for example 51 and 52, are disposed on one side of the solid. The holes 51 and 52 do not penetrate the rectangular solid 50 but form a flat surface 55 parallel to the exterior surface 54 of the bottom of the device. Disposed in each provided hole 51 and 52 is apiece of tactile material, such as a distinctive cloth, a piece of textured wallpaper, or a piece of ultrafine sandpaper.

In use the rectangular solid 50 is releasably attached to the underside of a child's school desk, as shown in HG, 6, by the use of two-sided tape of other means of temporarily affixing the invention to the desk or may be held by the child. The child may make use of the rectangular solid 50 generally outside the direct view of others in the classroom or other location of use. In a time of stress or other need, the child may reach for the invention and explore one or more of the feels in holes 51 or 52 of the rectangular solid 50.

1. A handheld, portable manipulative comprising tactile and visual feels and further comprising:
a plurality of distinct fabrics permanently affixed at the fabric edges;
sewn or otherwise bonded in a generally quilted manner;
in which the distinct fabrics provide distinct tactile feels; and
in which the distinct fabrics provide distinct color feels.

2. The device of claim 1 in which the apparatus further comprises non-fabric and partially fabric tactile and visual feels for a user.

3. The device of claim 2 in which the additional tactile feels further comprise a button and buttonhole configuration.

4. The device of claim 2 in which the additional tactile feels further comprise compressible or squeezable object embedded within the quilting.

5. The device of claim 2 in which the additional visual feel further comprises an image of interest to a user.

6. The d vice of claim 2 in which the additional visual feel further comprises a toy.

7. The device of claim 1 in which the tactile feel of at least one fabric of the plurality of distinct fabrics comprises a smooth fabric.

8. The device of claim 1 in which the tactile feelof at least one fabric of t plurality of distinct fabrics comprises a rough fabric.

9. The device of claim 1 in which the tactile feel of at least one fabric of the plurality of distinct fabrics comprises a ribbed fabric.

10. The device of claim 1 in which the tactile feel of at least one fabric of the plurality of distinct fabrics comprises a fabric into which are manufactured raised surfaces.

11. The device of claim 10 in which the raised surfaces further comprise patterned hemispherical objects.

12. The device of claim 10 in which the raised surfaces fur h comprise pa earned conical objects.

13. The device of claim 10 in which the raised surface comprise patterned rectangular solid objects.

14. The device of claim 1 in which quilting within different fabrics of the plurality of fabrics are of a plurality of thicknesses.

15. The device of claim 2 in which the additional tactile feels further comprise an embedded heatable object.

16. The device of claim 2 in which the additional tactile feels further comprise an embedded freezable object.

17. The device of claim 2 in which the additional tactile feels further comprise embedded coolable object.

18. The device of claim 2 in which the additional tactile feels vibrate.

19. A handheld or m table device comprising a rigid solid of suitable thickness and further comprising:
a plurality of recesses
in each of which recesses are permanently of releasably affixed objects of distinct sensory feels.

20. The device of claim 19 in which the device may be releasable affixed to underside of a desk or table.

21. The device of claim 19 in which the objects of distinct sensory feels are fabrics containing tactile artifacts.

22. The device of claim 19 in which the objects of distinct sensory feels are solids o distinct shape.

23. The device of claim 19 in which the object of distinct sensory feels vibrate.

24. A method of maintaining classroom order comprising the steps of:
a. Identifying a child suitable to receive classroom support for attention control.
b. Identifying a plurality of tactile feels of interest to the child.
c. Identifying a plurality of visual feels of interest to the child.
d. Assembling the plurality of tactile and visual feels of interest to the child in a single handheld or mountable manipulative.
e. Identifying suitable bases for providing the child with the manipulative.
f. Providing the child with the manipulative at identified times to control the child's attention.
